(19) United States
(12) Patent Application Publication
(10) Pub. No.: US 2007/0066345 A1
(43) Pub. Date: Mar. 22, 2007

(54) DUAL MODE FRONT END MODULE AND MOBILE TERMINAL HAVING THE SAME

(75) Inventors: IL-Youp HWANG, Gunpo (KR); Hun-Young SON, Seoul (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/531,742

(22) Filed: Sep. 14, 2006

(30) Foreign Application Priority Data
Sep. 16, 2005 (KR) 10-2005-0087107

(51) Int. Cl. H04B 7/08; H04M 1/00

(52) U.S. Cl. 455/553.1; 455/132

(57) ABSTRACT

A dual-mode front end module (FEM) includes an antenna switch module (ASM), a first filtering unit which filters signals of a first type that are outputted from the ASM, a single pole double throw (SPDT) switch, a second filtering unit which filters signals of a second type that are inputted to or outputted from the SPDT switch, and at least one antenna port for transmitting and receiving at least one of the signals of the first type and the signals of the second type.

This application claims the benefit of Korean Patent Application No. 10-2005-0087107, filed on Sep. 16, 2005, which is hereby incorporated by reference in its entirety.

### BACKGROUND

1. Field of the Invention

The present invention relates to a mobile terminal and, more particularly, to a mobile terminal with a dual mode front end module (FEM).

2. Description of the Related Art

Currently, mobile terminals are being developed which not only communicate voice signals, but also communicate data via Wireless Local Area Network (WLAN) standards, such as Wireless Fidelity (Wi-Fi).

FIG. 1 is a schematic block diagram showing an exemplary structure of a conventional mobile terminal which communicates voice signals.

The conventional mobile terminal shown in FIG. 1 includes an antenna 13 which receives radio frequency (RF) reception signals from a base station and transmits RF transmission signals to the base station, an RF unit 11 which processes the RF reception and transmission signals, and a first baseband processing unit 12 which processes baseband reception and transmission signals.

The RF unit 11 includes a front end module (FEM) 14, a transceiver 15 which converts RF reception signals to baseband reception signals, outputs the baseband reception signals to the first baseband processing unit 12 and receives baseband transmission signals from the first baseband processing unit 12, and a power amplifier module (PAM) 16 which amplifies RF transmission signals. Additionally, the RF unit 11 may include a modulator 17 which modulates RF transmission signals outputted by the transceiver 15.

The FEM 14 includes an antenna switch module (ASM) which switches the antenna 13 between a transmitting path and a receiving path of the RF unit 11, and a filtering unit which filters RF reception signals received by the antenna 13. The filtering unit typically includes at least one of a low pass filter (LPF), a surface acoustic wave (SAW) filter, and the like.

FIG. 2 is a schematic block diagram showing an exemplary structure of a conventional mobile terminal which is capable of communicating voice signals and WLAN signals.

The conventional mobile terminal shown in FIG. 2 includes all of the components of the conventional mobile terminal shown in FIG. 1 for communicating voice signals, and also includes an antenna 23 which receives RF reception signals from a WLAN access point or other transmission device and transmits RF transmission signals, a WLAN RF unit 21 which processes RF transmission and reception signals, and a second baseband processing unit 22 which processes baseband transmission and reception signals.

The WLAN RF unit 21 includes a band pass filter 24 which filters RF transmission and reception signals, a single pole double throw (SPDT) switch 25 which switches the antenna 23 between a transmitting path and a receiving path of the WLAN RF unit 21, a transceiver 26 which converts RF reception signals to baseband reception signals, outputs the baseband reception signals to the second baseband processing unit 22 and receives baseband transmission signals from the second baseband processing unit 22, and a power amplifier module (PAM) 27 which amplifies RF transmission signals.

The conventional mobile terminal shown in FIG. 2 communicates both voice signals and WLAN signals. However, one of its disadvantages is that the inclusion of the extra WLAN components undesirably increases the size of the mobile terminal.

Further, in a conventional mobile terminal such as that shown in FIG. 2, many internal components are connected by strip lines, which generate an insertion loss.

### SUMMARY

One of the features of the present invention is that it minimizes the size of a mobile terminal capable of communicating both voice and WLAN signals.

Another feature of the present invention is that it minimizes insertion losses due to strip lines in a mobile terminal capable of communicating both voice and WLAN signals.

To achieve at least these features there is provided a dual-mode front end module (FEM) which includes an antenna switch module (ASM), a first filtering unit which filters signals of a first type that are outputted from the ASM, a single pole double throw (SPDT) switch, a second filtering unit which filters signals of a second type that are inputted to or outputted from the SPDT switch, and at least one antenna port for transmitting and receiving at least one of the signals of the first type and the signals of the second type.

The first filtering unit may include at least one surface acoustic wave (SAW) filter, and a low pass filter (LPF). The second filtering unit may be a band pass filter (BPF). The ASM, the first filtering unit, the SPDT switch and the second filtering unit may be included in a single chip.

The ASM, the first filtering unit, the SPDT switch and the second filtering unit may be provided on a single circuit board. The signals of the first type may carry voice signals. The signals of the second type may be Wireless Local Area Network (WLAN) signals.

There is also provided a mobile terminal which includes a dual-mode front end module (FEM), a first RF unit that processes RF signals of a first type outputted from the dual-mode FEM, a first baseband processing unit that processes baseband signals outputted from the first RF unit, a second RF unit that processes RF signals of a second type outputted from the dual-mode FEM, and a second baseband processing unit that processes baseband signals outputted from the second RF unit.

The dual-mode FEM may include an antenna switch module (ASM) that outputs the RF signals of the first type, a first filtering unit that filters the RF signals of the first type, a single pole double throw (SPOT) switch, a second filtering unit that filters RF signals of the second type which are inputted to or outputted from the SPDT switch, and at least one antenna port that outputs at least one of RF signals of the first type and RF signals of the second type to at least one antenna, and inputs at least one of RF signals of the first type and RF signals of the second type from the at least one antenna.

The RF signals of the second type may be Wireless Local Area Network (WLAN) signals. The first RF unit may include a transceiver that converts RF reception signals of the first type to baseband reception signals, outputs the baseband reception signals to the first baseband processing unit, and receives baseband transmission signals of the first type from the first baseband processing unit, and a power amplifier module (PAM) that amplifies RF transmission signals of the first type. The signals of the first type may carry voice signals. The terminal may also include a modulator that modulates RF transmission signals of the first type which are outputted from the transceiver.

The second RF unit may include a transceiver that converts RF reception signals of the second type to baseband reception signals, outputs the baseband reception signals to the second baseband processing unit, and receives baseband transmission signals of the second type from the second baseband processing unit, and a power amplifier module (PAM) that amplifies RF transmission signals of the second type. The signals of the second type may be Wireless Local Area Network (WLAN) signals.

The terminal may also include a first antenna which transmits and receives RF signals of the first type, and a second antenna which transmits and receives RF signals of the second type. The signals of the first type may carry voice signals.

There is also provided a method of communicating signals of a first type and signals of a second type with a mobile terminal which includes receiving RF signals of a first type and RF signals of a second type at a dual-mode front end module (FEM) of a mobile terminal, outputting, by the dual-mode FEM, the RF signals of the first type to a first RF unit that processes the RF signals of the first type, and outputting, by the dual-mode FEM, the RF signals of the second type to a second RF unit that processes the RF signals of the second type.

The method may also include receiving the RF signals of the first type at a first antenna, outputting the received RF signals of the first type to an antenna switch module (ASM) of the dual-mode FEM, filtering the RF signals of the first type by a first filtering unit of the dual-mode FEM, receiving the RF signals of the second type at a second antenna, outputting the RF signals of the second type to a single pole double throw (SPDT) switch of the dual-mode FEM, and filtering the RF signals of the second type by a second filtering unit of the dual-mode FEM.

The method may also include outputting, by the first RF unit, RF transmission signals of the first type to the dual-mode FEM, outputting, by the second RF unit, RF transmission signals of the second type to the dual-mode FEM, and transmitting, from the dual-mode FEM, the RF transmission signals of the first type and the second type.

The method may also include receiving, by the ASM, the RF transmission signals of the first type, outputting, by the ASM, the RF transmission signals of the first type to the first antenna, receiving, by the SPDT, the RF transmission signals of the second type, filtering, by the second filtering unit, the RF transmission signals of the second type, and outputting, by the second filtering unit, the RF transmission signals of the second type to the second antenna. The signals of the first type may carry voice signals, and the signals of the second type may be Wireless Local Area Network (WLAN) signals.

Other exemplary embodiments and features of the present invention may be ascertained by reviewing the present disclosure and the accompanying drawings.

### BRIEF DESCRIPTION OF THE DRAWINGS

The present invention will become more fully understood from the detailed description given hereinbelow and the accompanying drawings, which are given by illustration only, and thus are not limitative of the present invention, and wherein:

FIG. 1 is a schematic block diagram showing an exemplary structure of a conventional mobile terminal which communicates voice signals;

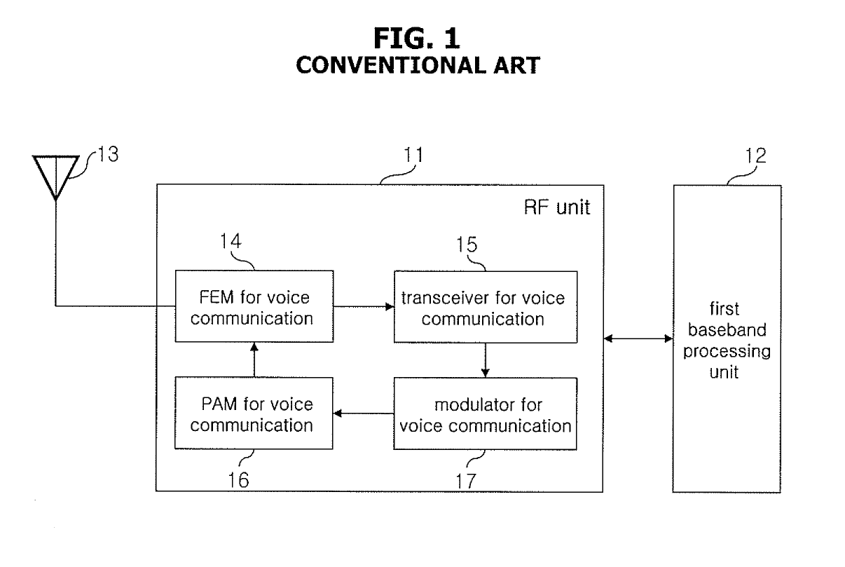

FIG. 2 is a schematic block diagram showing an exemplary structure of a conventional mobile terminal which is capable of communicating voice signals and WLAN signals;

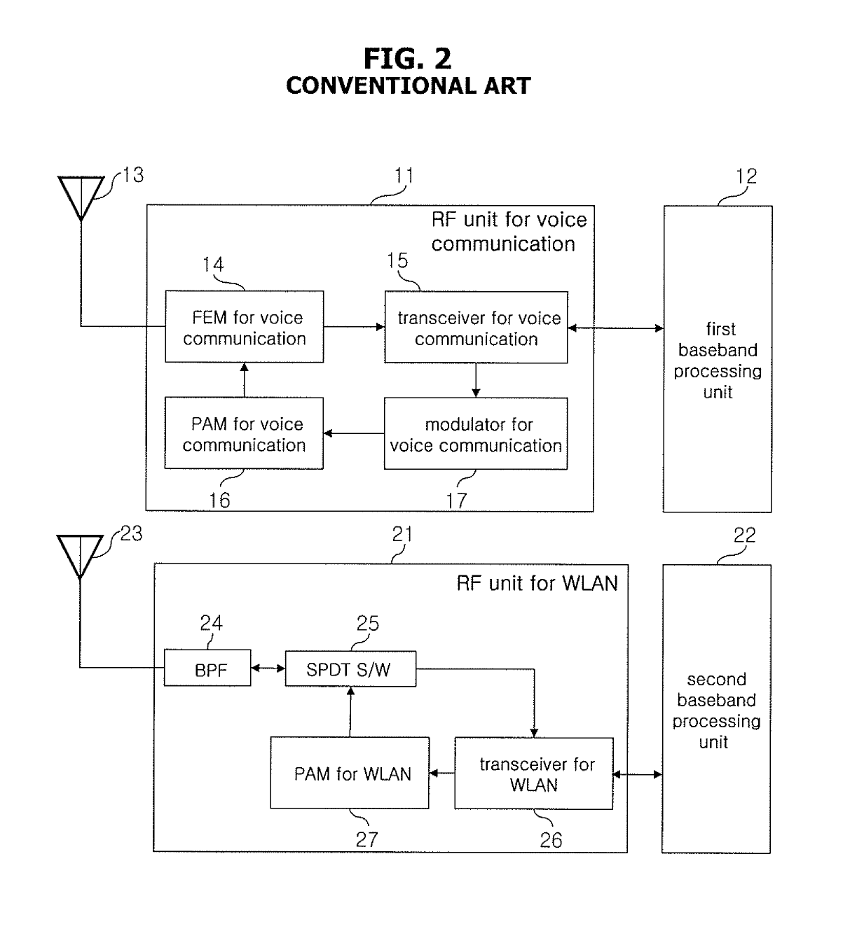

FIG. 3 is a layout view of an exemplary embodiment of a dual-mode FEM according to an aspect of the present invention; and

FIG. 4 is a schematic block diagram of an exemplary embodiment of a mobile terminal having the dual-mode FEM shown in FIG. 3.

### DETAILED DESCRIPTION

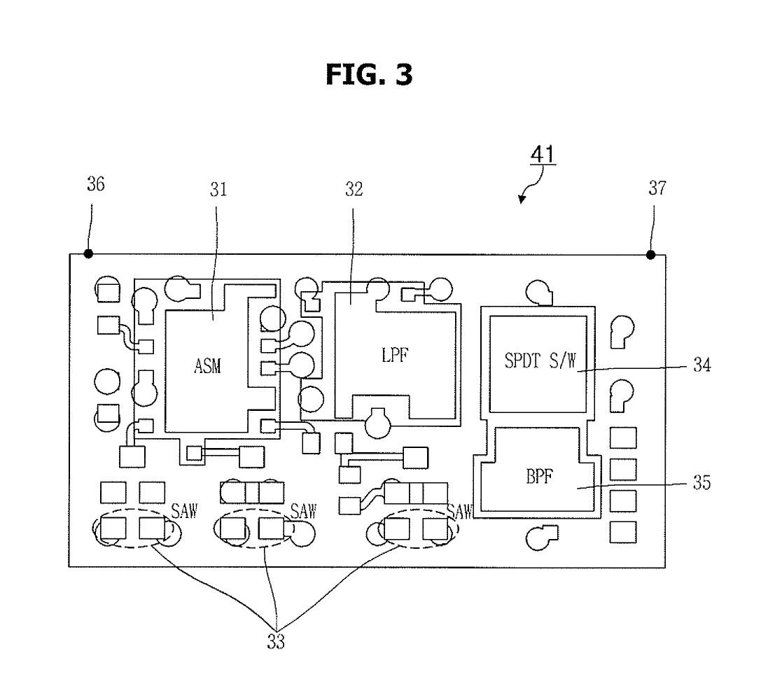

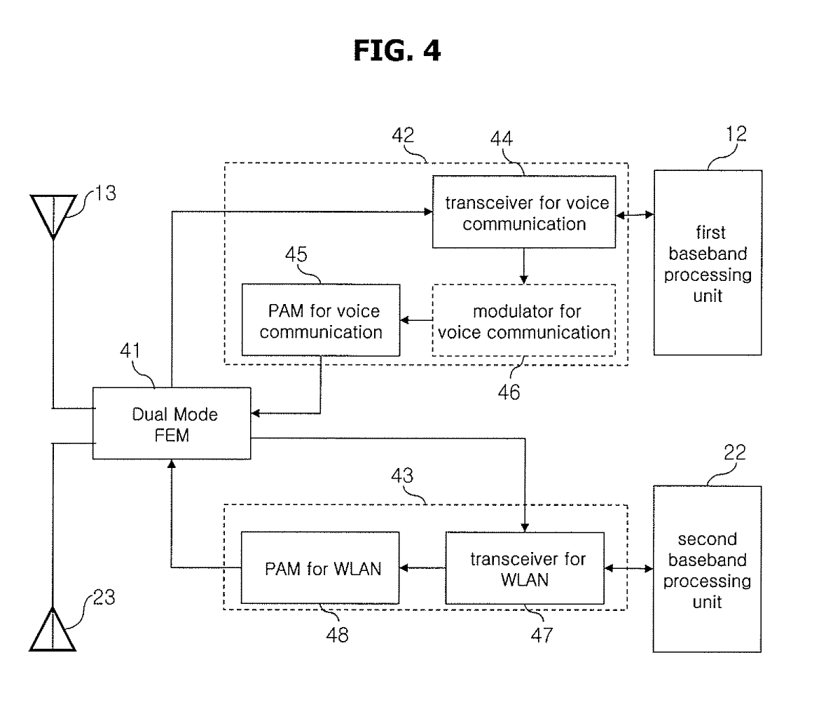

Described below is a dual-mode FEM which enables the size and connection insertion losses of a mobile terminal to be minimized. This is achieved by combining an FEM of an RF unit used for voice communication, an SPDT switch, and a BPF of a WLAN RF unit into a single module. An exemplary embodiment is described in more detail below with reference to FIGS. 3 and 4.

FIG. 3 is a layout view of an exemplary embodiment of a dual-mode FEM according to an aspect of the present invention.

The dual-mode FEM 41 shown in FIG. 3 includes an antenna switch module (ASM) 31, first filtering units 32 and 33 which filter RF voice communication signals outputted from the ASM 31, an SPDT switch 34, a second filtering unit 35 which filters RF WLAN communication signals inputted to and outputted from the SPDT switch 34, and antenna ports 36 and 37 which transmit and receive RF voice communication signals and RF WLAN communication signals.

The antenna ports 36 and 37 connect to antennas to allow the dual-mode FEM to communicate voice signals and WLAN signals. One of the antenna ports 36 and 37 connects to a first antenna which receives RF voice communication signals and the other of the antenna ports 36 and 37 connects to a second antenna which receives RF WLAN signals.

The first filtering units 32 and 33 filter RF voice communication signals. The first filtering units 32 and 33 may include, for example, a low pass filter (LPF) and at least one surface acoustic wave (SAW) filter.

The second filtering unit 35 filters WLAN communication signals. The second filtering unit 35 may be, for example, a band pass filter (BPF).

In one embodiment, the dual-mode FEM 41 may be implemented by providing the ASM 31, the first filtering units 32 and 33, the SPDT switch 34 and the second filtering unit 35 on a single printed circuit board (PCB).

In another embodiment, the dual-mode FEM 41 may be implemented by combining the ASM 31, the first filtering units 32 and 33, the SPDT switch 34 and the second filtering unit 35 on a single chip.

An exemplary embodiment of a mobile terminal which incorporates the dual-mode FEM shown in FIG. 3 is described below with reference to FIG. 4. The mobile terminal shown in FIG. 4 may be, for example, a GSM terminal, a GPRS terminal, an EDGE terminal, a WCDMA or CDMA terminal, or the like.

FIG. 4 is a schematic block diagram of an exemplary embodiment of a mobile terminal having the dual-mode FEM 41 shown in FIG. 3.

The mobile terminal shown in FIG. 4 includes a dual-mode FEM 41, a first RF unit 42 which processes RF voice communication signals, a first baseband processing unit 12 which processes baseband voice communication signals output from the first RF unit 42, a second RF unit 43 which processes RF WLAN communication signals, and a second baseband processing unit 22 which processes baseband WLAN communication signals output from the second RF unit 43. As the frequency bands of the RF voice communication signals and the RF WLAN communication signals are different, the mobile terminal includes a first antenna 13 which receives and transmits the RF voice communication signals, and a second antenna 23 which receives and transmits the RF WLAN communication signals.

When a base station transmits RF voice communication signals to the mobile terminal, the ASM 31 of the dual-mode FEM 41 receives the RF voice communication signals from the first antenna 13. These signals are filtered by the first filtering units 32 and 33 of the dual-mode FEM 41, and then outputted to the first RF unit 42.

To transmit RF voice communication signals to a base station, the first baseband processing unit 12 outputs baseband voice transmission signals to the first RF unit 42. A PAM 45 of the first RF unit 42 amplifies RF voice transmission signals and outputs them to the ASM 31 of the dual-mode FEM 41. The ASM 31 then outputs the RF voice transmission signals to the antenna 13 for transmission.

The first RF unit 42 includes a transceiver 44 which converts RF voice reception signals to baseband voice reception signals and outputs the baseband voice reception signals to the first baseband processing unit 12. The transceiver 44 also receives baseband voice transmission signals from the first baseband processing unit 12, converts the baseband voice transmission signals to RF voice transmission signals, and outputs the RF voice transmission signals to the PAM 45, which amplifies the RF voice transmission signals.

In some embodiments (such as when the mobile terminal is an EDGE mobile terminal), the first RF unit 42 may also include a modulator 45 which modulates the RF voice transmission signals

The PAM 45 outputs amplified RF voice transmission signals to the ASM 31 of the dual-mode FEM 41, which then outputs the RF voice transmission signals to the antenna 13 for transmission.

The second antenna 23 receives RF WLAN reception signals from a source, such as a WLAN access point, and outputs the RF WLAN reception signals to the dual-mode FEM 41. The dual-mode FEM 41 then outputs the RF WLAN reception signals to the second RF unit 43.

When the RF WLAN reception signals are outputted to the dual-mode FEM 41, they are filtered by the second filtering unit 35, and then outputted to the SPDT switch 34 of the dual-mode FEM 41. The SPDT switch 34 outputs the RF WLAN reception signals to a reception path of the second RF unit 43.

To transmit WLAN transmission signals, the second baseband processing unit 22 outputs baseband WLAN transmission signals to the second RF unit 43, which outputs RF WLAN transmission signals to the dual-mode FEM 41. The SPDT switch 34 of the dual-mode FEM 41 outputs the RF WLAN transmission signals to the second antenna 23 for transmission, via the second filtering unit 35.

The second RF unit 43 includes a transceiver 47 which receives RF WLAN reception signals from the SPDT switch 34, converts the RF WLAN reception signals to baseband WLAN reception signals, and outputs the baseband WLAN reception signals to the second baseband processing unit 22. The transceiver 47 also receives baseband WLAN transmission signals from the second baseband processing unit 22, converts the baseband WLAN transmission signals to RF WLAN transmission signals, and outputs the RF WLAN transmission signals to a PAM 48, which amplifies the RF WLAN transmission signals. The PAM 48 outputs the amplified RF WLAN transmission signals to the SPDT switch 34 of the dual-mode FEM 41. The SPDT switch 34 then outputs the RF WLAN transmission signals to the second filtering unit 35, where they are filtered before being transmitted through the second antenna 23.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

Although the invention has been described with reference to an exemplary embodiment, it is understood that the words that have been used are words of description and illustration, rather than words of limitation. As the present invention may be embodied in several forms without departing from the spirit or essential characteristics thereof, it should also be understood that the above-described embodiment is not limited by any of the details of the foregoing description, unless otherwise specified. Rather, the above-described embodiment should be construed broadly within the spirit and scope of the present invention as defined in the appended claims. Therefore, changes may be made within the metes and bounds of the appended claims, as presently stated and as amended, without departing from the scope and spirit of the invention in its aspects.

What is claimed is:

1. A dual-mode front end module (FEM), comprising:
an antenna switch module (ASM);
a first filtering unit which filters signals of a first type that are outputted from the ASM;
a single pole double throw (SPDT) switch;
a second filtering unit which filters signals of a second type that are inputted to or outputted from the SPDT switch; and
at least one antenna port for transmitting and receiving at least one of the signals of the first type and the signals of the second type.

2. The FEM according to claim 1, wherein the first filtering unit comprises:
at least one surface acoustic wave (SAW) filter; and
a low pass filter (LPF).

3. The FEM according to claim 1, wherein the second filtering unit is a band pass filter (BPF).

4. The FEM according to claim 1, wherein the ASM, the first filtering unit, the SPDT switch and the second filtering unit are included in a single chip.

5. The FEM according to claim 1, wherein the ASM, the first filtering unit, the SPDT switch and the second filtering unit are provided on a single circuit board.

6. The FEM according to claim 1, wherein the signals of the first type carry voice signals.

7. The FEM according to claim 1, wherein the signals of the second type are Wireless Local Area Network (WLAN) signals.

8. A mobile terminal, comprising:
a dual-mode front end module (FEM);
a first RF unit that processes RF signals of a first type outputted from the dual-mode FEM;
a first baseband processing unit that processes baseband signals outputted from the first RF unit;
a second RF unit that processes RF signals of a second type outputted from the dual-mode FEM; and
a second baseband processing unit that processes baseband signals outputted from the second RF unit.

9. The terminal according to claim 8, wherein the dual-mode FEM comprises:
an antenna switch module (ASM) that outputs the RF signals of the first type;
a first filtering unit that filters the RF signals of the first type, a single pole double throw (SPDT) switch;
a second filtering unit that filters RF signals of the second type which are inputted to or outputted from the SPDT switch; and
at least one antenna port that outputs at least one of RF signals of the first type and RF signals of the second type to at least one antenna, and inputs at least one of RF signals of the first type and RF signals of the second type from the at least one antenna.

10. The terminal according to claim 8, wherein the RF signals of the second type are Wireless Local Area Network (WLAN) signals.

11. The terminal according to claim 8, wherein the first RF unit comprises:
a transceiver that converts RF reception signals of the first type to baseband reception signals, outputs the baseband reception signals to the first baseband processing unit, and receives baseband transmission signals of the first type from the first baseband processing unit; and
a power amplifier module (PAM) that amplifies RF transmission signals of the first type,
wherein the signals of the first type carry voice signals.

12. The terminal according to claim 11, further comprising:
a modulator that modulates RF transmission signals of the first type which are outputted from the transceiver.

13. The terminal according to claim 8, wherein the second RF unit comprises:
a transceiver that converts RF reception signals of the second type to baseband reception signals, outputs the baseband reception signals to the second baseband processing unit, and receives baseband transmission signals of the second type from the second baseband processing unit; and
a power amplifier module (PAM) that amplifies RF transmission signals of the second type,
wherein the signals of the second type are Wireless Local Area Network (WLAN) signals.

14. The terminal according to claim 8, further comprising:
a first antenna which transmits and receives RF signals of the first type; and
a second antenna which transmits and receives RF signals of the second type.

15. The terminal according to claim 8, wherein the signals of the first type carry voice signals.

16. A method of communicating signals of a first type and signals of a second type with a mobile terminal, comprising:
receiving RF signals of a first type and RF signals of a second type by a dual-mode front end module (FEM) of a mobile terminal;
outputting, by the dual-mode FEM, the RF signals of the first type to a first RF unit that processes the RF signals of the first type; and
outputting, by the dual-mode FEM, the RF signals of the second type to a second RF unit that processes the RF signals of the second type.

17. The method according to claim 16, further comprising:
receiving the RF signals of the first type by a first antenna;
outputting the received RF signals of the first type to an antenna switch module (ASM) of the dual-mode FEM;
filtering the RF signals of the first type by a first filtering unit of the dual-mode FEM;
receiving the RF signals of the second type by a second antenna;
outputting the RF signals of the second type to a single pole double throw (SPDT) switch of the dual-mode FEM; and
filtering the RF signals of the second type by a second filtering unit of the dual-mode FEM.

18. The method according to claim 17, further comprising:
outputting, by the first RF unit, RF transmission signals of the first type to the dual-mode FEM;
outputting, by the second RF unit, RF transmission signals of the second type to the dual-mode FEM; and
transmitting, from the dual-mode FEM, the RF transmission signals of the first type and the second type.

19. The method according to claim 18, further comprising:
receiving, by the ASM, the RF transmission signals of the first type;
outputting, by the ASM, the RF transmission signals of the first type to the first antenna;
receiving, by the SPDT, the RF transmission signals of the second type;
filtering, by the second filtering unit, the RF transmission signals of the second type; and
outputting, by the second filtering unit, the RF transmission signals of the second type to the second antenna.

20. The method according to claim 16, wherein the signals of the first type carry voice signals, and the signals of the second type are Wireless Local Area Network (WLAN) signals.
